(19) United States
(12) Patent Application Publication
(10) Pub. No.: US 2021/0114245 A1
(43) Pub. Date: Apr. 22, 2021

(54) METHOD FOR DETERMINING CUTTING POSITIONS OF OPTICAL FILM

(71) Applicant: LG CHEM, LTD., Seoul (KR)

(72) Inventors: Soon Ki HEO, Daejeon (KR); Mun Cheon KWAK, Daejeon (KR); Eung Jin JANG, Daejeon (KR); Chan Soo KIM, Daejeon (KR); Kyu Hwang LEE, Daejeon (KR)

(21) Appl. No.: 17/253,027

(22) PCT Filed: Sep. 27, 2019
(86) PCT No.: PCT/KR2019/012659

§ 371 Date: Dec. 16, 2020

(30) Foreign Application Priority Data
Sep. 28, 2018 (KR) 10-2018-0115900

(51) Int. Cl. B26D 5/00; B26D 7/28

(52) U.S. Cl. CPC B26D 5/00; B26D 7/28

(57) ABSTRACT

Disclosed is a method that may include the steps of: (a) previously acquiring information on defect positions of the optical film along the length direction of the optical film; (b) dividing the whole area of the optical film into a plurality of large calculation areas for deriving a plurality of cutting positions, based on a normal cutting distance condition and minimum cutting distance condition in the length direction, and the information on the defect positions of the optical film; and (c) determining the cutting positions from an area, in which none of the cutting positions are determined in the length direction of the optical film, among the plurality of large calculation areas.

The present application is a National Phase entry pursuant to 35 U.S.C. § 371 of International Application No. PCT/KR2019/012659 filed Sep. 27, 2019, and claims priority to and the benefit of Korean patent application no. KR 10-2018-0115900 filed on Sep. 28, 2018, the entire contents of which are incorporated herein by reference.

### FIELD

The disclosure relates to a method for determining the cutting positions of a lengthwise extending optical film to form a plurality of sheet pieces by cutting the optical film along the width direction with intervals in the length direction.

### BACKGROUND

A display unit may be manufactured by attaching optical films, including a polarizing film, a retardation film, a brightness enhancement film and/or a diffusion film, onto the surface of a panel.

This optical film may be manufactured in the form of lengthwise extending film and may be prepared in the form of rolled film by winding.

The optical film in the form of roll may be unrolled lengthwise and may be previously cut along the width direction with intervals in the length direction so as to correspond to the size of a panel, thereby providing a plurality of optical film sheet pieces that can be separated from each other. This plurality of optical film sheet pieces may each be supplied to an optical film attachment system for manufacturing a display unit and attached to a panel.

As another example, the optical film may not be previously cut into a plurality of sheet pieces, may be supplied in the form of film laminated with a carrier film to an optical film attachment system, and may be unrolled lengthwise and conveyed. During the conveyance process, half-cutting may be performed in which the optical film is cut but the carrier film is not cut. Then, a plurality of optical film sheet pieces which are continuously arranged on the carrier film may be supplied to panels.

An optical film may be cut along the width direction with a predetermined interval in the length direction, and in general, the cutting interval may be determined to correspond to the width or length of a panel.

Meanwhile, during the manufacturing of an optical film, defects may be formed in the optical film due to the inflow of foreign materials and bubbles, and damage such as scratches and deformation. In this case, the cutting positions of the optical film need to be determined so as to minimize the loss of the film while excluding the defects.

In general, the optical-film cutting position for excluding defects may be determined to satisfy a normal cutting distance condition, a minimum cutting distance condition, and a maximum cutting distance condition.

The normal cutting distance condition may mean a distance condition for forming normal optical film sheet pieces containing no defect.

In order to prevent the optical film sheet piece from being caught between or separated from conveyor rolls in a system for cutting or attaching the optical film, the optical film sheet piece preferably has a length between the minimum length and the maximum length. The minimum cutting distance condition and the maximum cutting distance condition may be conditions determined in consideration of such minimum and maximum lengths. The maximum cutting distance may be set to the same length as the normal cutting distance.

FIG. 1 is a schematic flowchart showing an example of a conventional method for determining cutting positions of an optical film. The cutting positions of the optical film may be determined by the procedure described below.

First, an optical film extending in the length direction is transferred in one direction, and at this time, the predetermined positions of the optical film are set as initial cutting positions.

Then, whether or not there is a defect on the optical film in an area ranging from the set cutting position to a distance n times larger than the normal cutting distance (where n is an integer greater than 0) is checked by an imaging device for defect detection.

Then, depending on whether or not a defect is included in the area ranging from the set cutting position to the position spaced apart by the normal cutting distance, a new cutting position is determined as follows and the optical film is cut along the width direction.

If no defect is included in the area ranging from the set cutting position to the position spaced apart by the normal cutting distance, the position spaced apart from the set cutting position by the normal cutting distance is determined as a new cutting position and the optical film is cut at the new cutting position along the width direction.

Otherwise, if a defect is included in the area ranging from the set cutting position to the position spaced apart by the normal cutting distance, it is determined whether the distance from the set cutting position to a position immediately after the defect is greater than the minimum cutting distance. Accordingly, if the distance from the cutting position to the position immediately after the defect is larger than the minimum cutting distance, the position immediately after the defect is determined as a new cutting position and the optical film is cut at the new cutting position. If the distance from the cutting position to the position immediately after the defect is smaller than the minimum cutting distance, the position spaced apart from the set cutting position by the minimum cutting distance is determined as a new cutting position and the optical film is cut at the new cutting position.

In addition, if the length of the optical film remaining after the new cutting position is more than the normal cutting distance, it is possible to repeat the step of checking whether or not there is a defect in the area ranging from the set cutting position to a distance n times larger than the normal cutting distance, and the subsequent step.

FIG. 2 is a view showing an example of an optimized cutting position in comparison with the case in which an optical film having a plurality of defects formed thereon is cut by a conventional method for determining cutting positions of an optical film.

FIG. 2(a) is a view showing an example of the case in which an optical film is cut by a conventional method for determining cutting positions of the optical film. As shown therein, the optical film to be cut is repeatedly cut by the normal cutting distance along the length direction of the optical film. If there is a defect formed on the optical film, the optical film is cut at a position immediately after the defect, and if there are defects adjacent to each other within the normal cutting distance, the optical film is cut at a position immediately after the subsequent defect. However, in the case where there are defects adjacent to each other within the normal cutting distance, if the distance between the preceding cutting line and a position immediately after the subsequent defect is greater than the normal cutting distance, but the distance between the adjacent defects is within the minimum cutting distance, the cutting line immediately after the preceding cutting line is first cut at a position spaced apart by the normal cutting distance, and the subsequent cutting line is cut at a position spaced apart by the minimum cutting distance therefrom. In this case, a total of four normal sheet pieces (based on the optical film shown in FIG. 2(a) may be formed in area A of the optical film.

Meanwhile, FIG. 2(b) is a view showing an example of an optimized cutting position for comparison with FIG. 2(a). As shown therein, if the optical film is cut at a position further spaced downstream without being cut at a position immediately after defect B in the vicinity of defect B located upstream of area A so that the normal cutting distances in area A of the optical film can be included to the maximum, more normal sheet pieces (a total of five normal sheet pieces based on the optical film shown in FIG. 2(b)) than those in FIG. 2(a) may be formed in area A.

That is, in addition to the normal cutting distance and the minimum cutting distance, how many normal cutting distances can be included in the area between a defect and a defect also needs to be considered to determine the cutting positions.

The background art described above is known technology, which has been possessed by the present inventors for the conception of embodiments of the present disclosure or acquired during the conception, and must not be considered as known technology known to the general public prior to the filing of embodiments of the present disclosure.

### SUMMARY

Embodiments of the present disclosure intend to provide a method for determining cutting positions of a lengthwise extending optical film, which may determine optimal cutting positions of the optical film to form a plurality of sheet pieces by cutting the optical film along the width direction with intervals in the length direction.

A method for determining cutting positions of an optical film according to an embodiment of the present disclosure is a method for determining cutting positions of a lengthwise extending optical film to form a plurality of optical film sheet pieces by cutting the optical film along a width direction of the optical film, at intervals in a length direction of the optical film. The method may include the steps of: (a) previously acquiring information on defect positions of the optical film along the length direction of the optical film; (b) dividing the whole area of the optical film into a plurality of large calculation areas for deriving a plurality of cutting positions, based on a normal cutting distance condition and minimum cutting distance condition in the length direction of the optical film, and the information on the defect positions of the optical film; (c) determining the cutting positions from an area, in which none of the cutting positions are determined in the length direction of the optical film, among the plurality of large calculation areas.

According to embodiments of the present disclosure, there is an advantage in that defect-free normal sheet pieces can be derived in a large calculation area to the maximum by setting the large calculation area for simultaneously determining cutting positions of a plurality of areas in which areas between defects are consecutively arranged.

### BRIEF DESCRIPTION OF THE DRAWINGS

FIG. 1 is a schematic flowchart showing an example of a conventional method for determining cutting positions of an optical film.

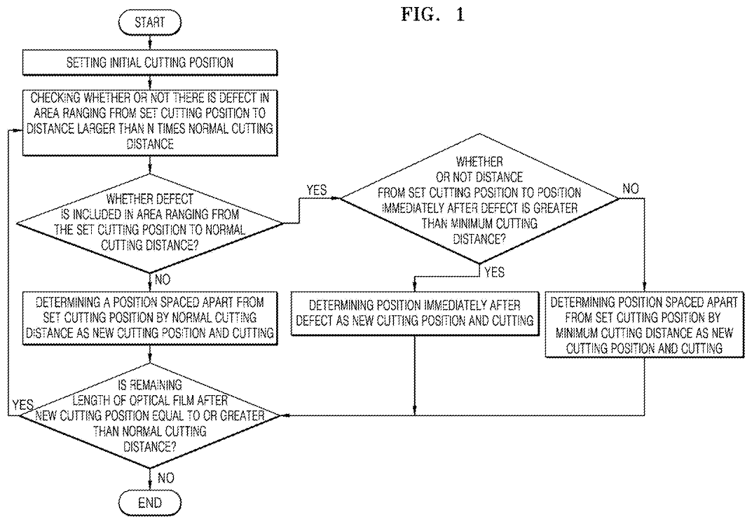

FIGS. 2(a)-2(b) are views showing examples of optimized cutting positions in comparison with the case in which an optical film having a plurality of defects formed thereon is cut by a conventional method for determining cutting positions of an optical film.

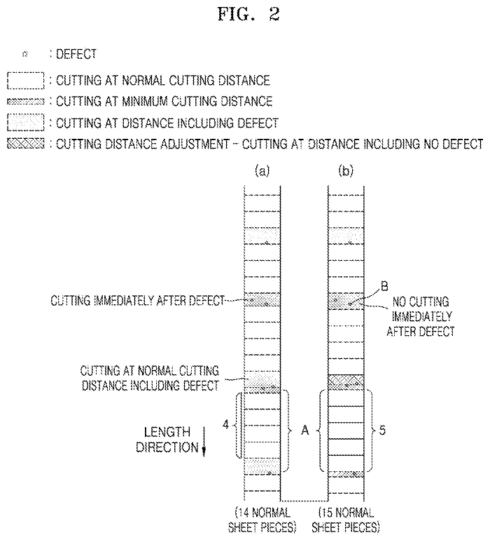

FIG. 3 is a flow chart showing a method for determining cutting positions of an optical film according to one embodiment of the present disclosure.

FIG. 4 is a view schematically showing an example of an optical film to which a method for determining cutting positions of an optical film according to one embodiment of the present disclosure is to be applied.

FIG. 5 is a view schematically showing another example of an optical film to which a method for determining cutting positions of an optical film according to one embodiment of the present disclosure is to be applied.

FIG. 6 is a detailed flow chart showing a method for determining cutting positions of an optical film according to one embodiment of the present disclosure.

### DESCRIPTION OF REFERENCE NUMERALS

dₙ: normal cutting distance

dₘᵢₙ: minimum cutting distance

α: minimum spacing distance

B: large calculation area

S: small calculation area

Sₐ: previous small calculation areas

Sₘ: selected small calculation area

S_{b}: subsequent small calculation area

### DETAILED DESCRIPTION

A method for determining cutting positions of an optical film according to an embodiment of the present disclosure is a method for determining cutting positions of a lengthwise extending optical film to form a plurality of optical film sheet pieces by cutting the optical film along a width direction of the optical film with intervals in a length direction of the optical film. The method may include the steps of: (a) previously acquiring information on defect positions of the optical film along the length direction of the optical film; (b) dividing the whole area of the optical film into a plurality of large calculation areas for deriving a plurality of cutting positions, based on a normal cutting distance condition and minimum cutting distance condition in the length direction of the optical film, and the information on the defect positions of the optical film; and (c) determining the cutting positions from an area, in which none of the cutting positions are determined in the length direction of the optical film, among the plurality of large calculation areas.

In this embodiment, step (b) may include the steps of: (b-1) setting a normal area, in which at least one normal cutting distance may be included, in a determination target area between any one of a first setting position and a defect and a defect adjacent to the any one, as a first small calculation area for deriving the cutting positions, and if defective areas, in which the normal cutting distance may not be included, in a determination target area between any one of a first setting position and a defect and a defect adjacent to the any one, are consecutive to each other, setting the normal area, including all the consecutive defective areas, as a second small calculation area for deriving the cutting positions; (b-2) calculating the maximum quantity of normal cutting in which the normal cutting distances may be included to the maximum in the small calculation area set through step (b-1); and (b-3) for a subsequent small calculation area, including any one small calculation area, classifying, as a large calculation area, an area including up to the first small calculation area, in which the remainder (hereinafter referred to as the small calculation area remainder) obtained by subtracting the product of the normal cutting distance and the maximum quality of normal cutting from the length of the small calculation area is smaller than the minimum cutting distance.

In this embodiment, the cutting positions are determined so that they maintain a distance equal to or greater than a predetermined minimum spacing distance from the defects, and the maximum quantity of normal cutting in step (b-2) is preferably an integer portion calculated by dividing a value, obtained by subtracting twice the minimum spacing distance from the length of the small calculation area, by the normal cutting distance.

In this embodiment, step (c) may include selecting the small calculation area from among the plurality of small calculation areas in the large calculation area in the order in which the small calculation area remainder is smaller, and determining the cutting positions in the selected small calculation area.

In this embodiment, step (c) may include step (c-1) of determining the cutting positions in the selected small calculation area, based on the small calculation area remainder of each of the selected small calculation area, the previous small calculation area and the subsequent small calculation area, and the minimum cutting distance, in the length direction of the optical film.

In this embodiment, step (c) may include step (c-2) of substituting a value, obtained by subtracting the distance between a defect present between the selected small calculation area and the previous small calculation area and the final cutting position in the previous small calculation area from the small calculation area remainder of the previous small calculation area, with the previous small calculation area remainder, if the cutting positions in the previous small calculation area before the selected small calculation area have been determined along the length direction of the optical film. Step (c-1) may be performed after step (c-2).

In this embodiment, step (c) may include step (c-3) of substituting a value, obtained by subtracting the distance between a defect present between the selected small calculation area and the subsequent small calculation area and the first cutting position in the subsequent small calculation area from the small calculation area remainder of the subsequent small calculation area, with the subsequent small calculation area remainder, if the cutting positions in the small calculation area subsequent to the selected small calculation area have been determined in the length direction of the optical film. Step (c-1) is preferably performed after step (c-3).

In this embodiment, the cutting positions in step (c) are determined so that the distance between the cutting positions adjacent to each other does not exceed a predetermined maximum cutting distance, and the maximum cutting distance is preferably the same as the normal cutting distance.

The present disclosure will become apparent with reference to the embodiments described below in detail in conjunction with the accompanying drawings. However, the present disclosure is not limited to the embodiments disclosed below, but may be embodied in various different forms. These embodiments are only provided so that this disclosure will be thorough and complete, and will fully convey the scope of the present disclosure to those skilled in the art. The scope of the present disclosure is defined only by the claims. Meanwhile, terms used in the present specification are for the purpose of explaining the embodiments and are not intended to limit the present disclosure. As used herein, the singular forms are intended to include the plural forms as well, unless the context clearly indicates otherwise. The terms “comprises” and/or “comprising”, as used in the present specification, specify the presence of stated elements, steps, operations and/or components, but do not preclude the presence or addition of one or more other elements, steps, operations and/or components. The terms “first”, “second”, etc. may be used to describe various components, but the components are not limited by the terms. The terms are used only for the purpose of distinguishing a component from other components.

Hereinafter, the present disclosure will be described in detail with reference to the accompanying drawings.

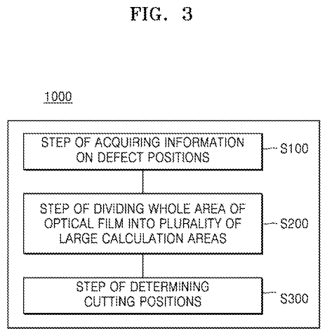

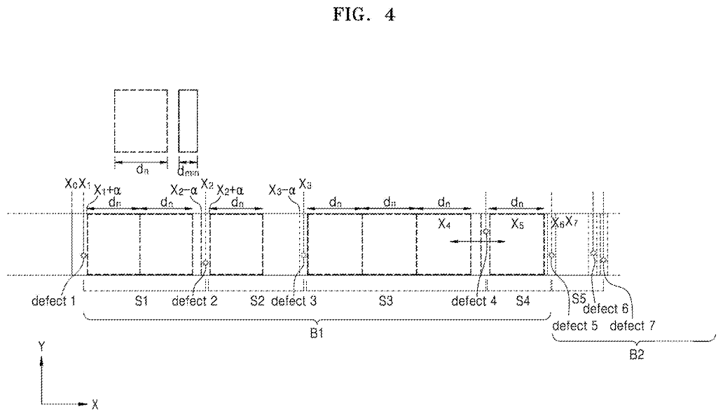

FIG. 3 is a flow chart showing a method for determining cutting positions of an optical film according to one embodiment of the present disclosure, and FIG. 4 is a view schematically showing an example of an optical film to which a method for determining cutting positions of an optical film according to one embodiment of the present disclosure is to be applied.

A method for determining cutting positions of an optical film according to an embodiment of the present disclosure is a method 1000 for determining cutting positions of a lengthwise extending optical film to form a plurality of optical film sheet pieces by cutting the optical film along a width direction of the optical film with intervals in a length direction of the optical film.

This optical film cutting position determination method 1000 may include the steps of: (a) previously acquiring information on defect positions of the optical film based on the length direction of the optical film (defect position information acquisition step; s100); (b) dividing the whole area of the optical film into a plurality of large calculation areas for deriving a plurality of cutting positions, based on a normal cutting distance condition and minimum cutting distance condition in the length direction of the optical film, and the information on the defect positions of the optical film (a step of dividing the whole area of the optical film into a plurality of large calculation areas, s200); and (c) determining the cutting positions from an area in which none of the cutting positions are determined in the length direction of the optical film, among the plurality of large calculation areas (a step of determining cutting positions, s300). The optical film cutting position determination method 1000 may be performed by at least one information processing unit.

In step (a) (s300), using a certain position in the length direction (see FIG. 4; the x-axis direction) of an optical film (F) as a start point x₀, information on the positions of defects (see FIG. 4; defect 1 to defect 6) on the optical film (F) is previously acquired as positions relative to the starting point x₀. Here, the expression “information is acquired” means calculating the defect positions of the optical film as coordinates of positions relative to the starting point. Such coordinate information may be data that may be identified and processed by a data processing unit. Such coordinate information may be stored in a database or separately marked as codes, which may be identified by a reader, on the optical film by ink or a laser.

In step (b) (s200), based on the normal cutting distance condition and minimum cutting distance condition in the length direction of the optical film, and the information on the defects positions of the optical film, the whole area of the optical film may be divided into a plurality of large calculation areas for deriving a plurality of cutting positions. The normal cutting interval (d₀) condition may be determined based on the distance for forming a normal optical film sheet piece including no defect. Since the normal optical film sheet piece is attached to a panel, the normal cutting distance (dₙ) condition may be determined to correspond to the length or width of the panel. The minimum cutting distance (dₘᵢₙ) condition may be determined in consideration of the minimum length necessary to prevent the optical film sheet piece from being caught between or separated from conveyor rolls for conveying the optical film sheet piece in a system for cutting or attaching the optical film.

Step (b) (s200) may include the steps of: (b-1) dividing and setting the whole area of the optical film into a plurality of small calculation areas; (b-2) calculating the maximum quantity of normal cutting in the small calculation areas; and (b-3) classifying and setting certain small calculation areas, including any one small calculation area, as a large calculation area.

Hereinafter, steps (b-1), (b-2) and (b-3) will be described in detail.

In step (b-1), in a determination target area ((x₀+dₘᵢₙ) to defect m or defect n to defect m) between any one of a first setting position (x₀+dₘᵢₙ) and defect n and defect m adjacent to the any one, a normal area, in which at least one normal cutting distance (d₀) may be included, may be set as a first small calculation area for deriving the cutting position. In addition, in step (b-1), in the determination target area between any one of the first setting position (x₀+dₘᵢₙ) and defect n and a defect adjacent to the any one, an area including all consecutive defective areas, in which the normal cutting area (d₀) may not be included, may be set as a second small calculation area for deriving the cutting position.

Here, the first setting position (x0+dₘᵢₙ) may be, for example, a position spaced by the minimum cutting distance (dₘᵢₙ) from the starting point (x0) which is one end or a certain position in the length direction of the optical film. If the first setting position (x0+dₘᵢₙ) is a position after the first defect (defect 1) appearing after the starting point (x0), the determination target area may be an area (defect 2) between the first defect (defect 1) appearing after the starting point (x0) and a defect (defect 2) adjacent to the first defect. Meanwhile, if at least one normal cutting distance (dₙ) may be included in the determination target area, the determination target area may be set as a first small calculation area. In addition, in the determination target area between any one of the first setting position (x₀+dₘᵢₙ) and defect n and a defect adjacent to the any one, a defective area, in which the normal cutting distance (dₙ) may not be included, may be set as a second small calculation area. If these defective areas are consecutive to each other, an area including all the consecutive defective areas may be set as a second small calculation area for deriving the cutting position. For example, in the optical film shown in FIG. 4, a determination area (x₆ to x₅) between defect 5 and defect 6, and a determination area (x₇ to x₆) between defect 6 (x₆) and defect 7 (x₇) are all defective areas in which the normal cutting distance (d₁) may not be included. Since these defective areas are consecutive to each other, an area including all these defective areas may be set as a second small calculation area (S5).

Step (b-2) may calculate the maximum quantity of normal cutting in which the normal cutting distances (d₀) may be included to the maximum in the first and second small calculation areas (hereinafter may be referred to as ‘small calculation areas’) set through step (b-1). In this embodiment, the cutting position is preferably determined so that it maintains a spacing distance equal to or greater than a predetermined minimum spacing distance (a) from the defects (defect n and defect m). In this case, in the step (b-2), the maximum quantity of normal cutting may be an integer portion calculated by dividing a value, obtained by subtracting twice the minimum spacing distance from the length of the small calculation area, by the normal cutting distance. For example, in the optical film shown in FIG. 4, the maximum quantity of normal cutting of normal cutting, in which the normal cutting distances (dₙ) may be included to the maximum in the small calculation area (S1) most adjacent to the starting point (x₀) may be the integer 2 calculated by dividing a value (x₂−x₁−2 α), obtained by subtracting twice (2α) the minimum spacing distance (α) from the length (x₂−x₁) of the small calculation area (S1), by the normal cutting distance (dₙ). The maximum quantities of normal cutting in the subsequent small calculation areas (S2, S3, S4 and S5) based on the optical film shown in FIG. 4 may be 1, 3, 1 and 0, respectively.

In step (b-3), for subsequent small calculation areas including any one small calculation area, small calculation areas including up to the first small calculation area, in which the remainder obtained by subtracting the product of the normal cutting distance and the maximum quantity of normal cutting from the length of the small calculation areas (hereinafter, the remainder is referred to as the small calculation area remainder) is smaller than the minimum cutting distance, may be classified and set as a large calculation area. For example, for subsequent small calculation areas (S2, S3, S4, S5 . . . ) including the small calculation area (S1) most adjacent to the starting point (x₀) based on the optical film shown in FIG. 4, small calculation areas including up to the first small calculation area (S4), in which the small calculation area remainder (x₃−x₂−1*dₙ, x₄−x₃−3*dₙ, x₅−x₄−1*dₙ, x₇−x₅−0*dₙ) obtained by subtracting the product (1*dₙ, 3*dₙ, 1*dₙ, 0*dₙ) of the normal cutting distance (d₀) and the maximum quantity of normal cutting (1, 3, 1, 0) from the length (x₃−x₂, x₄−x₃, x₅−x₄, x₇−x₅) of the small calculation areas is smaller than the minimum cutting distance (drain), may be classified and set as a large calculation area (B1).

In step (c) (s300), the cutting position may be determined from areas in which none of the cutting positions are determined, in the length direction of the optical film among the plurality of large calculation areas. For example, based on the optical film shown in FIG. 4, if none of the cutting positions in the large calculation area (B1) adjacent to the starting point (x₀), among the plurality of large calculation areas (B1, B2, . . . ), are determined, the cutting position may be determined from the corresponding large calculation area (B1) in the length direction (B2, . . . ) of the optical film.

In (c) step (s300), the small calculation area may be selected from among the plurality of small calculation areas in the large calculation area in the order in which the small calculation area remainder is smaller, and the cutting position in the selected small calculation area may be determined. For example, based on the optical film shown in FIG. 4, the small calculation area may be selected from among the plurality of small calculation areas (S1, S2, S3, S4) in the large calculation area (B1) adjacent to the starting point (x₀), in the order in which the small calculation area remainder (x₂−x₁−2*dₙ, x₃−x₂−1*dₙ, x₄−x₃−3*dₙ, x₅−x₄−1*dₙ) is smaller (S4, S1, S3, S2), and the cutting position in the selected small calculation area may be determined.

Step (c) (s300) may include step (c-1) of determining the cutting position in the selected small calculation area based on the small calculation area remainder of each of the selected small calculation area, the previous small calculation area and the subsequent small calculation area, and the minimum cutting distance, in the length direction of the optical film. Meanwhile, if the selected small calculation area is the first small calculation area appearing in the length direction of the optical film, the previous small calculation area may not be separately present. For this reason, in this case, the minimum cutting distance may be set as the small calculation area remainder of the previous small calculation area.

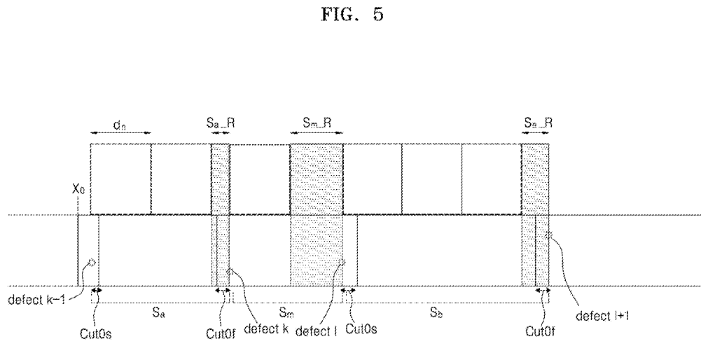

FIG. 5 is a view schematically showing another example of an optical film to which the optical film cutting position determination method according to one embodiment of the present disclosure is to be applied.

In step (c-1), the smaller value (Small) among the previous small calculation area remainder (S_{a_}R) and the subsequent small calculation area remainder (S_{b_}R) is first extracted (c-11). In addition, the sum (S_{n_}R+Small) of the selected small calculation area remainder (S_{n_}R) and the smaller value (Small) is compared with the minimum cutting distance (dₘᵢₙ) (c-12). If ‘S_{n_}R+Small’ is determined to be greater than ‘dₘᵢₙ’ through step (c-12), each of the selected small calculation area remainder (S_{n_}R) and the smaller value (Small) is compared with the minimum cutting distance (dₘᵢₙ) (c-13). If ‘S_{n_}R’ and ‘Small’ are all determined to be smaller than ‘dₘᵢₙ’ through step (c-13), the first spacing distance (Cut0s) at which defect k between the selected small calculation area (Sₘ) and the previous small calculation area (Sₐ) is spaced downward, and the final spacing distance (Cut0f) at which defect 1 between the selected small calculation area (Sₘ) and the subsequent small calculation area (S_{b}) is spaced upward, are set as a value obtained by subtracting the smaller value (Small) from the minimum cutting distance (dₘᵢₙ) (c-14). That is, the first cutting position in the selected small calculation area (Sₘ) is set as a position spaced downstream from defect k by the first cutting distance (Cut0), and the final cutting position is set as a position spaced upstream from defect 1 by the final cutting distance (Cut0f).

Meanwhile, if at least one of ‘S_{n_}R’ and ‘Small’ is determined to be equal to or greater than through step (c-13), the first cutting distance (Cut0s) and the final cutting distance (Cut0f) are set as ½ of the small calculation area remainder (S_{m_}R) of the selected small calculation area (Sₘ) (c-15). Next, the sum of the smaller value (Small) and the first and final cutting distances (Cut0s, Cut0f) set through the step (c-14) or (c-15) is compared with the minimum cutting distance (dₘᵢₙ) (C-16). If ‘Cut0s+Small’ and ‘Cut0f+Small’ are determined to be smaller than through step (c-16), ‘Cu0s+S_{a_}R’ and ‘Cut0f+S_{b_}R’ are all adjusted to be equal to or greater than the minimum cutting distance and if the adjustment is impossible, one of ‘Cut0s’ and ‘Cut0f’ is adjusted so that any one of ‘Cu0s+S_{a_}R’ and ‘Cut0f+S_{b_}R’ becomes the minimum cutting distance (dₘᵢₙ) (c-17).

Meanwhile, if ‘S_{n_}R+Small’ is determined to be equal to or smaller than through step (c-12), the previous small calculation area remainder (S_{a_}R) is compared with the subsequent small calculation area remainder (S_{b_}R) (c-18). If ‘S_{a_}R’ is determined to be greater than ‘S_{b_}R’ through step (c-18), the final cutting distance (Cut0f) is set as a value (Cut0f=S_{n_}R−α) obtained by subtracting the minimum spacing distance (α) from the selected small calculation area remainder (S_{m_}R) (c-19). Meanwhile, if ‘S_{a_}R’ is determined to be equal to or smaller than ‘S_{b_}R’ through step (c-18), the first cutting distance (Cut0s) is set as the minimum spacing distance (α) (Cut0s=a) (c-20).

Meanwhile, if ‘Cut0s+Small’ and ‘Cut0f+Small’ are determined to be equal to or greater than ‘dₘᵢₙ’ through step (c-16), the repeating positions spaced from each other by the normal cutting distance in the selected small calculation area (Sₘ) are determined as cutting positions (c-21), based on the first cutting position or final cutting position defined by any one of ‘Cut0s’ and ‘Cut0f’, any one of ‘Cut0s’ and ‘Cut0f’ finally adjusted through step (c-17), and any one of ‘Cut0f’ set through step (c-19) and ‘Cut0s’ set through step (c-20).

The sum (Cut0s+S_{a_}R) of the first cutting distance (Cut0s), determined by any one of step (c-20) and step (c-21), and the small calculation area remainder (S_{a_}R) of the previous small calculation area (Sₐ) is compared with the normal cutting distance (d₀) (c-22). If ‘Cut0s+S_{a_}R’ is determined to be greater than ‘dₙ’ through step (c-22), an additional cutting position is set between the first cutting position and a position spaced upstream from defect k by ‘S_{a_}R’. Specifically, a position spaced downstream by the minimum cutting distance (dₘᵢₙ) from a position spaced upstream from defect k by ‘S_{a_}R’ is set as the additional cutting position (c-22).

Step (c) (S300) may include step (c-2) of substituting a value, obtained by subtracting the distance (Cut0f) between defect k present between the selected small calculation area (Sₘ) and the previous small calculation area (Sₐ) and the final cutting position in the previous small calculation area (Sₐ) from the small calculation area remainder (S_{a_}R) of the previous small calculation area, with the previous small calculation area remainder, if the cutting positions (the cutting positions defined by Cut0s and Cut0f determined in the previous small calculation area (Sₐ)) in the previous small calculation area (Sₐ) before the selected small calculation area (Sₘ) have been determined in the length direction of the optical films. In this case, step (c-1) is performed after step (c-2).

Step (c) (S300) may include step (c-3) of substituting a value, obtained by subtracting the distance (Cut0s) between defect 1 present between the selected small calculation area (Sₘ) and the subsequent small calculation area (S_{b}) and the first cutting position in the subsequent small calculation area from the small calculation area remainder (S_{b_}R) of the subsequent small calculation area, with the subsequent small calculation area remainder, if the cutting positions (the cutting positions defined by Cut0s and Cut0f determined in the subsequent small calculation area (S_{b})) in the small calculation area (S_{b}) subsequent to the selected small calculation area (Sₘ) have been determined in the length direction of the optical film. In this case, step (c-1) is performed after step (c-3).

In step (c) (S300), the cutting positions are determined so that the distance between the cutting positions adjacent to each other does not exceed the predetermined maximum cutting distance. The maximum cutting distance is preferably the same as the normal cutting distance.

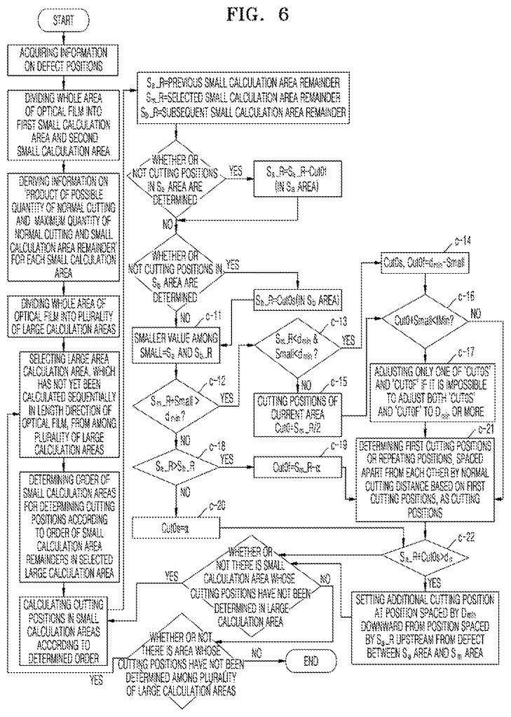

FIG. 6 is a detailed flow chart showing the optical film cutting position determination method according to one embodiment of the present disclosure.

According to the embodiments of the present disclosure, there is an advantage in that defect-free normal sheet pieces can be derived in a large calculation area to the maximum by setting the large calculation area for simultaneously determining cutting positions of a plurality of areas in which areas between defects are consecutively arranged.

Although the present disclosure has been described in connection with the above-mentioned preferred embodiments, various modifications or alterations are possible without departing from the gist and scope of the present disclosure. Accordingly, the appended claims will cover such modifications and alternations variations that fall within the gist of the present disclosure.

1. A method for determining cutting positions of a lengthwise extending optical film to form a plurality of optical film sheet pieces by cutting the optical film along a width direction of the optical film with intervals in a length direction of the optical film, the method comprising the steps of:
(a) previously acquiring information on defect positions of the optical film based on the length direction of the optical film;
(b) dividing a whole area of the optical film into a plurality of relatively large calculation areas for deriving a plurality of cutting positions, based on a normal cutting distance condition and minimum cutting distance condition in the length direction of the optical film, and the information on the defect positions of the optical film; and
(c) determining the cutting positions from an area, in which none of the cutting positions are determined in the length direction of the optical film, among the plurality of large calculation areas.

2. The method of claim 1, wherein step (b) comprises the steps of:
(b-1) setting a normal area, in which at least one normal cutting distance may be included, among a determination target area between any one of a first setting position and a defect and a defect adjacent to the any one, as a first relatively small calculation area for deriving the cutting positions, and if defective areas, in which the normal cutting distance may not be included, among a determination target area between any one of a first setting position and a defect and a defect adjacent to the any one, are consecutive to each other, setting the normal area, including all the consecutive defective areas, as a second relatively small calculation area for deriving the cutting positions;
(b-2) calculating the maximum quantity of normal cutting in which the normal cutting distances may be included to the maximum in the small calculation area set through step (b-1); and
(b-3) for a subsequent relatively small calculation area, including any one relatively small calculation area, classifying as a relatively large calculation area an area including up to the first relatively small calculation area, in which a small calculation area remainder obtained by subtracting the product of the normal cutting distance and the maximum quality of normal cutting from the length of the relatively small calculation area is smaller than the minimum cutting distance.

3. The method of claim 2, wherein
the cutting positions are determined so that they maintain a distance equal to or greater than a predetermined minimum spacing distance from the defects, and
the maximum quantity of normal cutting in step (b-2) is an integer portion calculated by dividing a value, obtained by subtracting twice the minimum spacing distance from the length of the relatively small calculation area, by the normal cutting distance.

4. The method of claim 2, wherein step (c) comprises selecting the relatively small calculation area from among the plurality of relatively small calculation areas in the relatively large calculation area in the order in which the relatively small calculation area remainder is smaller, and determining the cutting positions in the selected relatively small calculation area.

5. The method of claim 4, wherein step (c) comprises step (c-1) of determining the cutting positions in the relatively selected small calculation area, based on the small calculation area remainder of each of the selected relatively small calculation area, the previous relatively small calculation area and the subsequent relatively small calculation area, and the minimum cutting distance, in the length direction of the optical film.

6. The method of claim 5, wherein step (c) comprises step (c-2) of substituting a value, obtained by subtracting the distance between a defect present between the selected relatively small calculation area and the previous relatively small calculation area and the final cutting position in the previous relatively small calculation area from the small calculation area remainder of the previous relatively small calculation area, with the previous small calculation area remainder, if the cutting positions in the relatively small calculation area before the selected relatively small calculation area have been determined in the length direction of the optical film, and
step (c-1) is performed after step (c-2).

7. The method of claim 5, wherein step (c) comprises step (c-3) of substituting a value, obtained by subtracting the distance between a defect present between the selected relatively small calculation area and the subsequent small calculation area and the first cutting position in the subsequent relatively small calculation area from the small calculation area remainder of the subsequent relatively small calculation area, with the subsequent relatively small calculation area remainder, if the cutting positions in the relatively small calculation area subsequent to the selected relatively small calculation area have been determined in the length direction of the optical film, and
step (c-1) is performed after step (c-3).

8. The method of claim 1, wherein the cutting positions in step (c) are determined so that the distance between the cutting positions adjacent to each other does not exceed a predetermined maximum cutting distance, and
the maximum cutting distance is the same as the normal cutting distance.
